(19) United States
(12) Patent Application Publication
(10) Pub. No.: US 2020/0070049 A1
(43) Pub. Date: Mar. 5, 2020

(54) GAMING SYSTEM AND METHOD FOR ATTACK TARGETED AT COORDINATES

(71) Applicant: FINCON CO., LTD., Seongnam-si (KR)

(72) Inventors: Chung Gil YU, Suwon-si (KR); Seok Hyun CHAE, Seongnam-si (KR); Jin Hong PARK, Seongnam-si (KR)

(21) Appl. No.: 16/339,668

(22) PCT Filed: Sep. 26, 2017
(86) PCT No.: PCT/KR2017/010617

§ 371 Date: Apr. 4, 2019

(30) Foreign Application Priority Data
Oct. 6, 2016 (KR) 10-2016-0129222

(51) Int. Cl. A63F 13/426; A63F 13/56; A63F 13/822

(52) U.S. Cl. CPC A63F 13/426; A63F 13/56; A63F 2300/807; A63F 2300/306; A63F 2300/8076; A63F 13/822

(57) ABSTRACT

Provided are gaming system and method for attack targeted at coordinates which provides a game for executing a combat between a target and a user character by displaying a target image for a target which is an attack target of a user, applying a coordinate system to the corresponding target image, and moving a user character attacking the target in an attack range preset in the coordinate system to correspond to the target.

### CROSS-REFERENCE TO RELATED APPLICATIONS

This application is based on and claims the benefit of priority to Korean Patent Application No. 10-2016-0129222 filed on Oct. 6, 2016, with the Korean Intellectual Property Office, the disclosure of which is incorporated herein by reference.

### BACKGROUND OF THE INVENTION

### Field of the Invention

The present invention relates to gaming system and method for attack targeted at coordinates, and more particularly, to gaming system and method for attack targeted at coordinates which provides a game executing a combat between a target and a user character by displaying a target image for a target which is an attack target of a user, applying a coordinate system to the corresponding target image, and moving a user character attacking the target in an attack range preset in the coordinate system to correspond to the target.

### Description of the Related Art

Currently, with the development of various game engines that provide precise physical effects and various graphics-related software and hardware for supporting the various game engines, various types of games have been provided.

As an example, a game of a genre such as a first-person shooter (FPS) or a role play game (RPG) provides an active combat game that removes a target by using a gun provided in a game in response to a real-time operation of a user or removes the target based on a unique feature of a character by operating various characters provided in the game.

As another example, strategic combat games provide a game of supporting the user to establish a variety of strategies and perform a combat against targets or opponents and automatically perform an actual combat by an algorithm to play the game.

In recent years, a real-time strategy (RTS) game that adds elements of RPG to the combat game as a strategy combat game which is played in real time generally provides a game in which resources are collected, buildings are constructed or military strengths are produced with the resources, and the game ends when civilization is developed and the user wins the combat, and various strategies can be applied and actual combats are executed by the operation of the user.

However, in most of the recent games, since the game is played according to the real-time user's operation, a difference in game level among users is considerably widened according to a skill of the user, which makes it difficult for a beginner to easily access.

Therefore, it is required to develop an alternative game which can improve accessibility to the game by acquiring a simple operation and game rules even for the beginner.

In addition, since the game genre as described above is fixed, the users are easily tired of the game in the same manner as the game in the related art, and as a result, a demand for developing a new type of game is increasing.

### SUMMARY OF THE INVENTION

The present invention has been made in an effort to provide a new genre of game in which an FPS genre to attack a target by moving movement coordinates to an attack region which is a weak point of the target and a strategy simulation genre through a combination of user characters attacking the attack region of the target are combined and a game that may continuously inspire an interest of a user by providing a fun of attacking various targets with different attack regions by displaying a target image for a target to be attacked in a game, applying a coordinate system to the corresponding target image, and moving movement coordinates corresponding to the attack region by a movement attribute of a user character having the movement attribute to move the movement coordinates moving the coordinate system set in any one coordinate of an attack region for attacking the target and the remaining coordinates other than the corresponding attack region to the corresponding coordinate system to attack the target by execution of a combat between the target and the user character.

Further, the present invention has been made in an effort to provide a game which a beginner may also easily access by supporting a simple operation through various combinations of user characters having different attributes.

An exemplary embodiment of the present invention provides a gaming system for attack targeted at coordinates, which includes: a game executing unit configured to provide game information through a user apparatus and execute a game corresponding to a stage selected by a user based on the game information; a target providing unit configured to display a target image for a target corresponding to the stage in association with the game executing unit, set a coordinate system preset in the game information on the target image to correspond to the stage, and display an attack region of the target preset in the game information in the target image; and a game control unit configured to configure a party by grouping one or more selection characters selected according to a user input through the user apparatus within the number of selected characters preset to correspond to the stage among a plurality of different user characters included in the game information, set a starting point of the party on a coordinate system of the target image and display a movement coordinate which moves on the coordinate system at the starting point, and execute a combat between the target and the selection character according to the game information by considering a final location of the movement coordinate and the attack region on the coordinate system by moving the movement coordinate on the coordinate system according to a movement attribute for each selection character included in the party.

As an example related to the present invention, the game control unit may identify a difficulty level corresponding to the target set in the game information and vary a resolution of the coordinate system or vary a size of the attack region according to the identified difficulty level.

As an example related to the present invention, the movement attribute may include a movement direction and a movement distance, and the game control unit may move the movement coordinate on the coordinate system according to the movement direction and the movement distance depending on the movement attribute set in the selection character.

As an example related to the present invention, the game information may include information on a combat attribute including a physical level and an attack level for each of the user character and the target, and the game control unit may vary the combat attribute of the selection character according to a separation distance depending on the attack region and a final location of the movement coordinate, subtract the physical level of the target by executing the combat based on the combat attributes of the selection character and the target, and output result information for a determination result by determining whether a mission is achieved according to whether the physical level of the target is exhausted through the user apparatus.

As an example related to the present invention, the game control unit may display each attack region on the target image when there are a plurality of attack regions corresponding to the target, determine whether the mission is achieved for each attack region by executing the combat after moving the movement coordinate to each attack region from the starting point according to the movement attribute of each party by generating a plurality of parties corresponding to the plurality of attack regions, respectively according to a user input, and determine that the achievement of the mission for the stage is successful when the achievement of the mission for all attack regions of the target is successful.

As an example related to the present invention, the game information may include information on a weak point attribute and a tolerance attribute of the target corresponding to the attack region and an attack attribute of the selection character, and the game control unit may apply a weight preset in the game information to the combat attribute of the selection character of which the attack attribute coincides with any one of the weak point attribute and the tolerance attribute and subtract the physical level of the target according to the combat attribute to which the weight is applied at the time of executing the combat.

As an example related to the present invention, the weak point attribute and the tolerance attribute and the attach attribute may be attributes set to have a preset grade or compatibility to correspond to the user character.

As an example related to the present invention, the game control unit may calculate a movement direction depending on an angle between a selection location and a current location of the movement coordinate selected according to the user input and a movement location of the movement coordinate depending on the movement attribute for each user character and sort and display the user characters in an order in which the selection location and the movement location are closer according to a calculation result.

As an example related to the present invention, the target image may be configured by a 3D stereoscopic image, the coordinate system is configured in 3D, and the movement attribute may include a 3D movement direction and a 3D movement distance.

Another exemplary embodiment of the present invention provides a gaming method for attack targeted at coordinates by a game application unit configured in a user apparatus and executing a game, which includes: providing game information through the user apparatus, executing a game corresponding a stage selected by a user based on the game information, and providing a target image corresponding to the stage to a game screen through a display of the user apparatus; setting a coordinate system preset in the game information in the target image to correspond to the stage and displaying an attack region of the target preset in the game information on the target image; displaying a movement coordinate which moves on the coordinate system; and configuring a party by grouping one or more selection characters selected according to a user input through the user apparatus within the number of selected characters preset to correspond to the stage among a plurality of different user characters included in the game information and executing a combat between the target and the selection character according to the game information by considering a final location of the movement coordinate and the attack region on the coordinate system by moving the movement coordinate on the coordinate system according to a movement attribute for each selection character included in the party.

According to the present invention, it is possible to provide a coordinate attack game which moves movement coordinates aiming at an attack region in accordance with movement attributes set in a plurality of user characters constituting a party so as to approach the attack region for attacking a target and executes a combat between the party constituted by the plurality of user characters according to the corresponding movement coordinates and executes the combat by varying a combat attribute of the user character according to aiming accuracy of the movement coordinates for the attack region to provide a game that inspires an interest of a user who becomes bored with the existing uniformed genre and guarantees a fun to attack various attacks having different attack regions by providing a new genre of game in which an FPS genre to attack the attack region by moving movement coordinates corresponding to an aiming point and a strategy simulation genre to attack the attack region by arranging user characters constituting a party at a specific point with movement of the movement coordinates.

Further, according to the present invention, it is possible to provide a game in which a beginner may also easily access through a simple operation of combining the plurality of user characters into the party.

Furthermore, a user provides a mission to be achieved only by establishing an optimal strategy by considering both a scheme of combining user characters that may move movement coordinates closest to the attack region of the target at the time of constituting a party for removing the target by using the plurality of user characters and a scheme of the user characters according to a combat attribute which is interacted between the target and the user character in order to efficiently remove the target at the time of executing the combat between the target and the user character to guarantee diversity of the game and exclude a uniformed strategy by supporting the combination of various user characters to be generated with respect to the same target, thereby inspiring an interest of the user in the game.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram of a gaming system for attack targeted at coordinates according to an embodiment of the present invention;

FIG. 2 is a configuration diagram for a target image and a coordinate system according to an embodiment of the present invention;

FIGS. 3 and 4 are operational exemplary diagrams for a game execution in the gaming system for attack targeted at coordinates according to the embodiment of the present invention;

FIG. 5 is an operational exemplary diagram for a combat execution in the gaming system for attack targeted at coordinates according to the embodiment of the present invention;

FIG. 6 is a flowchart of an operation for determining mission achievement in the gaming system for attack targeted at coordinates according to the embodiment of the present invention;

FIG. 7 is an exemplary diagram illustrating a combat execution process according to combat attributes of a target and a character in the gaming system for attack targeted at coordinates according to the embodiment of the present invention; and

FIGS. 8 and 9 are exemplary diagrams illustrating a sorting process for user characters in the gaming system for attack targeted at coordinates according to the embodiment of the present invention.

### DETAILED DESCRIPTION OF THE PREFERRED EMBODIMENT

Hereinafter, detailed embodiments of the present invention will be described with reference to the drawings.

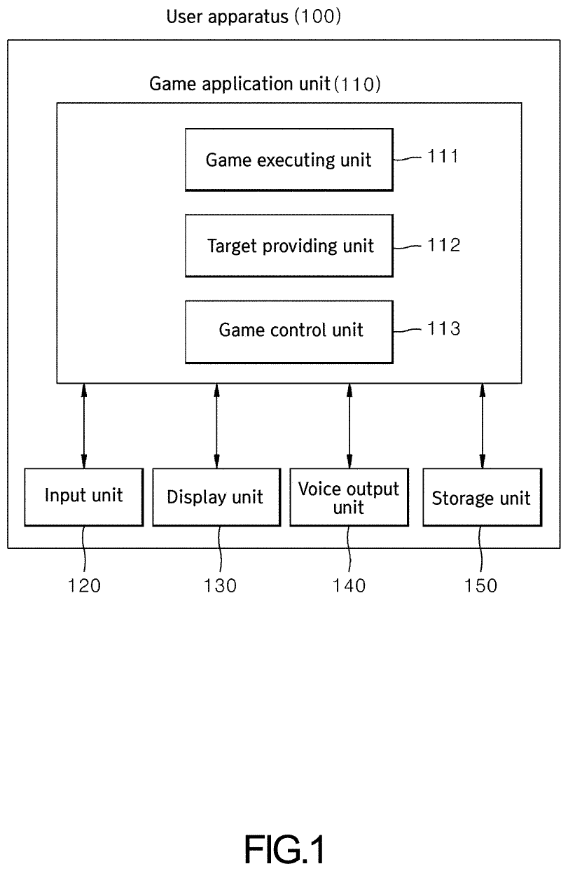

FIG. 1 is a configuration diagram of a gaming system for attack targeted at coordinates according to an embodiment of the present invention. As illustrated in FIG. 1, the gaming system may include a game application unit 110, an input unit 120, a display unit 130, a voice output unit 140, and a storage unit 150, which are constituted in a user apparatus 100 to execute a coordinate attack game.

In this case, the game application unit 110 may be configured as a control unit for controlling each configured portion configured on the user apparatus 100 and executes the control function of the user apparatus 100 using programs and the data stored in the storage unit 150. For example, the game application unit 110 may include a RAM, a ROM, a CPU, a GPU, and a bus, and the RAM, the ROM, the CPU, and the GPU may be connected to each other via a bus. Further, the game application unit 110 may perform booting using an operating system (O/S) stored in the storage unit 150 and perform various operations using data, programs, contents, and the like related to various applications stored in the storage unit 150.

Furthermore, the respective configuration units 120, 130, 140, and 150 including the gaming application unit 110 may be implemented by a hardware circuit (e.g., a CMOS-based logic circuit), firmware, software, or a combination thereof. For example, the apparatuses and components may be embodied by using a transistor, a logic gate, and an electronic circuit in the forms of various electric structures.

In addition, the storage unit 150 may store various data for the execution of the coordinate attack game, and the game application unit 110 may read the game data stored in the storage unit 150 to execute the coordinate attack game.

The input unit 120 may receive a signal according to a button operation or any function selection by the user, receive a command or a control signal generated by an operation of touching/scrolling a displayed screen, or receive a signal corresponding to information input by a touch input of the user. As the input unit, various apparatuses such as a keyboard, a mouse, a joystick, a touchpad (static pressure/electrostatic), a touch screen, a stylus pen, and a touch pen may be used.

In addition, the display unit 130 may display a variety of contents including a game screen (game image) in accordance with the execution of the game data stored in the storage unit 150 by the control of the game application unit 110.

The input unit 120 and the display unit 130 may be configured as configuration units for configuring the touch screen of the user apparatus 100, and at this time, a touch sensor for detecting a user's touch gesture may be included. The touch sensor may be one of various types, such as an electrostatic type, a pressure-sensitive type, and a piezoelectric type.

Further, the voice output unit 140 which outputs voice information included in a predetermined signal processed by the game application 110 may be configured in the user apparatus 100 and the voice output unit may include a receiver, a speaker, a buzzer, and the like.

Furthermore, the user apparatus 100 described in the present invention may include various terminals, such as a smart phone, a portable terminal, a mobile terminal, a personal digital assistant (PDA), a portable multimedia player (PMP) terminal, a telematics terminal, a navigation terminal, a personal computer, a notebook computer, a slate PC, a tablet PC, an ultrabook, a wearable device (e.g., including a smartwatch, a smart glass, a head mounted display (HMD), etc.), a Wibro terminal, an internet protocol television (IPTV) terminal, a smart TV, a digital broadcasting terminal, an audio video navigation (AVN) terminal, an audio/video (A/V) system, and a flexible terminal.

In addition, the storage unit 150 may include one or more game engine-related data for the execution of the game data, the game engine provides one or more simulation logics for the execution of the coordinate attack game, and the game application unit 110 may execute the coordinate attack game through the simulation logic.

According to the aforementioned configuration, the game application 110 displays a target image for a target which is an attack target of the coordinate attack game, sets a coordinate system in the corresponding target image, and then display a predetermined attack region A configured by one ore more coordinates on the corresponding coordinate system to correspond to the target on the target image.

In this case, of course, the game application unit 110 may just simply apply the coordinate system without displaying the coordinate system on the target image.

Further, the game application unit 110 configures a party by grouping one or more selection characters selected by the user among user characters having movement attributes for removing the target, sets a starting point of the party and a movement coordinate B moving the coordinate system corresponding to the party to move the movement coordinate B on the coordinate system based on a movement attribute for each selection character configuring the party, adjusts an attack level for each selection character configuring the party according to a final location of the movement coordinate B and an approaching degree of the attack region A, and then executes a combat between the target and the selection character based on the simulation logic to determine whether a mission is achieved according to a removal of the target.

At this time, the game application unit 110 moves the movement coordinate B based on the movement attribute for each user character selected by the user to control to aim the attack region A, identifies a separation distance between the attack region A and the movement coordinate B at aiming accuracy, varies a combat attribute of each user character included in the party according to the corresponding aiming accuracy, and then executes the combat according to the simulation logic based on the combat attribute of the target and the combat attribute of the user character included in the party to determine the success of the mission achievement when the target is removed.

That is, the game application unit 110 provides the movement coordinate B as a configuration similar to the aiming point of a first-person shooter (FPS) and determines the aiming accuracy of the movement coordinate B depending on the party configuration according to the combination of the user characters moving the movement coordinates B, thereby providing a new type of game combining an FPS genre and a strategy simulation genre.

Further, the game application unit 110 determines the issue of the combat between the target and the party according to the combat attributes of the target and the user character included in the party when executing the combat with the target at a final location of the movement coordinate B by the movement attribute for each user character included in the party to consider the combat attribute of the user character together when the party is configured and configure a combination of various user characters for the same target, thereby securing variety of game aspects.

Through the aforementioned configuration, the present invention may provide a game by combining user characters having a movement attribute capable of moving the movement coordinate B so as to approach the attack region A set on the target to configure a party, strategically combining the user characters capable of moving the party to the attack region A which is a weak point of the target by approaching maximally the corresponding party to the attack region A to execute the combat with the target, and removing the target according to the execution of the combat between the user character included in the party and the target. Therefore, the present invention may provide a new genre of game by moving the movement coordinate B to a weak point of the target such as the aiming point of the FPS to perform the attack to the weak point of the target by the user character and combing a strategy simulation genre for attacking the weak point of the target by moving the user character according to a movement location of the movement coordinate B with the FPS genre.

In addition, the present invention may inspire the user's interest by setting a different attack region A for each target and providing a strategic element for the party configuration to effectively attack the weak point of the target.

Hereinafter, detailed embodiments of the present invention will be described based on the aforementioned configuration.

As illustrated in FIG. 1, the game application unit 110 may include a game executing unit 111, a target providing unit 112, and a game control unit 113.

At this time, of course, all of the configuration units constituting the game application unit 110 are not required components, and the game application unit 110 maybe implemented by more components than those illustrated in FIG. 1 or implemented by fewer components therethan, and the any one configuration unit constituting the game application unit 110 may be include in another configuration unit.

First, the detailed operation of each configuration unit constituting the game application unit 110 based on the configuration of FIG. 1 will be described through the following drawings.

The game executing unit 111 may provide the game information stored in the storage unit 150 through the display unit 130.

At this time, the game executing unit 111 provides stage information for each stage included in the game information for the execution of the coordinate attack game, and the “stage” may refer to a unit game in which one or more missions are set and independently executed and a cyber space where the unit game is performed.

Further, the game information may include target-related target information for a predetermined target corresponding to each stage, user character-related character information selectable according to a user input for attacking and removing the target through the combat with the target, and the like.

At this time, the target information may include various information, such as combat attribute information (damage according to the attack accuracy rate for the user character, a level (attack level), a physical level, a defense level for attack of user characters, a weakness attribute and a tolerance attribute defined in the game, etc.), a target image (2D or 3D image), attack region A information for the attack region A of the target configured by one or more coordinates, and difficulty level information for the difficulty level of the target.

In addition, character information for each different user character may be included in the game information, and the character information may include various information, such as movement attribute information for the movement attribute moving the movement coordinate B, combat attribute information applied to the combat with the target (a damage level according to attack accuracy rate for the target, a physical level, a capacity level or a damage level according to a predetermined special function, a defense level for the attack of the target, an attack attribute defined in the game, etc.), and images (2D or 3D images) for each type of user character.

In addition, the game information may include item information about various items available on the stage, and the item information may include various information, such as attribute information of each type of item (e.g., attack power rises, defense power rises, etc. of an attack object).

In addition, the game information may include one or more of the game engine related data.

As described above, the game executing unit 111 may provide the game information on the display unit 130 of the user apparatus 100 and receive user input information by the input unit 120 to execute a game corresponding to the selection stage selected by the user among the stages based on the game information.

At this time, the game information may be set in the connection order of different stages, and the game executing unit 111 may also automatically execute the game on the stage corresponding to a next order of the specific stage according to the connection order when the game on the specific stage ends in association with the game control unit 113.

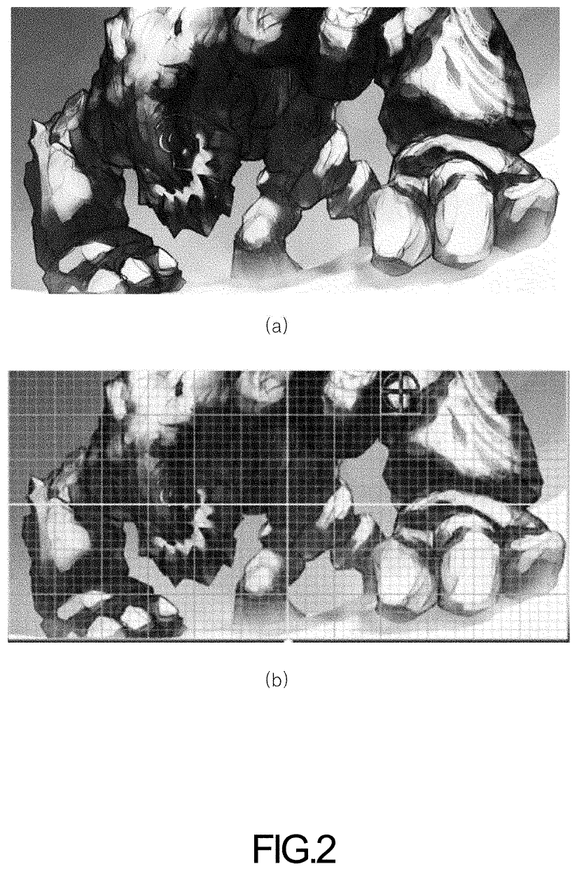

Meanwhile, as illustrated in FIG. 2A, when executing the game in associated with the game executing unit 111, the target providing unit 112 may provide the target image for the target corresponding to the selection stage to the game screen through the display unit 130 of the user apparatus 100 based on the target information included in the game information to correspond to the selection stage.

Further, as illustrated in FIG. 2B, the target providing unit 112 may set the coordination system on the target image, identify the attack region A of the target in the coordinate system based on the attack region A-related information of the target included in the target information corresponding to the selection stage, and display the corresponding attack region A on the target image.

At this time, the corresponding attack region A may be configured as a weak point of the target, and may be configured as any one coordinated of a plurality of coordinates constituting the coordinate system or a set of the plurality of coordinates.

Further, the target providing unit 112 may just simply set the coordinate system without displaying the coordinate system applied on the target image or display visually the coordinate system on the corresponding target image.

Further, the target providing unit 112 may adjust the number of coordinates (or cells) constituting the coordinate system according to the difficulty level information included in the target information to adjust the resolution of the coordinate system. For example, a coordinate system having a resolution of 300×200 may be applied to a first difficulty level and a coordinate system having a resolution of 600×400 may be applied to a second difficulty level.

In addition, the coordinate system may be configured by a 2D or 3D grid.

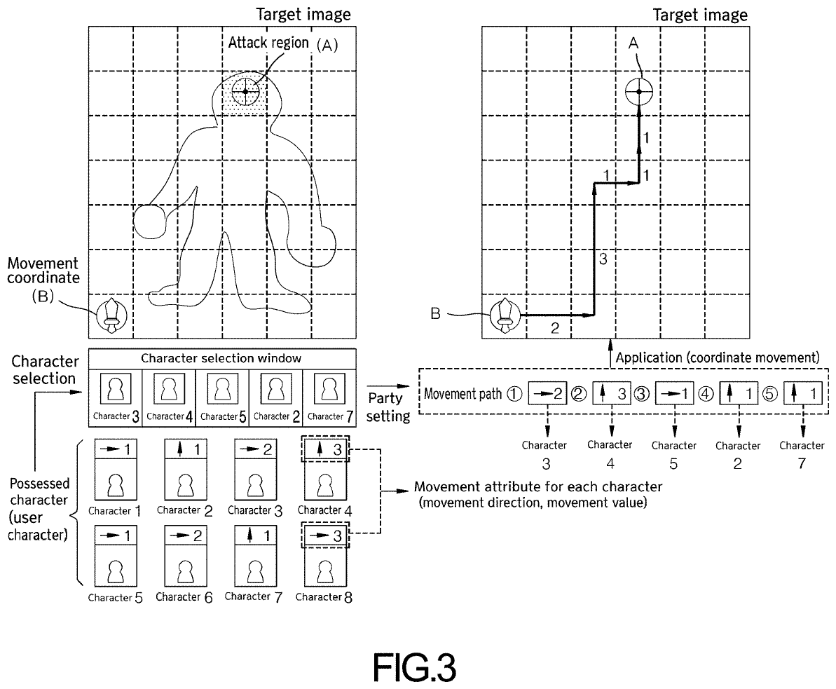

Meanwhile, as illustrated in FIG. 3, the game control unit 113 may provide a plurality of user characters on the display unit 130 based on the character information for each of the plurality of user characters stored in the game information in order to remove the target when executing the game in association with the game executing unit 111.

At this time, the game control unit 113 may generate character list information about the user characters possessed by the user based on the information on the plurality of characters and then display the generated character list information together with the target image on the display unit 130, and the character list information and the target image may be displayed in different regions of the game screen.

Further, the game control unit 113 may display the movement coordinate B moving on the coordinate system on the target image, and randomly set an initial location of the movement coordinate B on the coordinate system in the remaining region except for the attack region A or locate and display the movement coordinate B on the coordinate system according to a predetermined coordinate location (or point) corresponding to the selection stage.

Here, the location described in the present invention may refer to a specific coordinate value or a specific cell on the coordinate system.

In this case, each user character may include a movement attribute for moving the movement coordinates B, the movement attribute may include a movement direction and a movement value (movement distance).

Further, the character information of each user character may include movement attribute information about one or more movement attributes and each movement attribute may include a movement direction and a movement value.

In the aforementioned configuration, the movement coordinate B may be configured the same as the aiming point provided in a general FPS game, and there is a difference in that in the FPS game, the aiming point moves to a user's desired location on the coordinate system according to the user input, but in the coordinate attack game according to the present invention, the movement coordinate B moves according to the movement attribute of the user character selected by the user.

Meanwhile, the game control unit 113 may display a character selection window on the display unit 130 of the user apparatus 100 to select the user character in the predetermined number of characters selected to correspond to the selection stage according to the game information and display the character selection window in the character information and a region of the game screen different from a display region of the target image.

Further, the game control unit 113 inserts one or more selection characters selected by the user from the plurality of user characters according to the character list information based on the user input by the input unit 120 of the user apparatus 100 to the character selection window and set each selection character included in the character selection window as one party.

That is, the game control unit 113 may set one or more selection characters included in the character selection window as one group.

In this case, the game information may include stage information corresponding to each stage, and the stage information may include target information, mission information about a mission achievement condition corresponding to the stage, setting information about the character selection number configurable as a party in the corresponding stage, and compensation information about a compensation when the mission is achieved according to the mission information.

Here, the compensation information may be configured to increase by a predetermined capacity level with respect to some parameters of additional user character payouts or combat attributes of user characters possessed by the user, but is not limited thereto, and various compensations may be set.

Thereafter, the game control unit 113 may identify a movement direction and a movement value (movement distance) according to the movement attribute set for each selection character based on the character information for each selection character included in the party when the party configuration is completed based on the user input by the input unit 120 and move the movement coordinate B on the coordinate system according to the identified movement direction and movement value.

For example, the game control unit 113 may move the movement coordinate B by 2 in a right direction from the current location according to the movement attribute of selection character 3 included in the party and move the movement coordinate B by 3 in an upper direction from the current location moved by the movement attribute of the selection character 3 according to a movement attribute of selection character 4 included in the patty.

According to this method, the game control unit 113 may sequentially move the movement coordinate B according to a movement attribute of each of selection characters 2, 5, and 7 included in the party and determine a final location of the movement coordinate B when the movement attributes of all of the selection characters configured in the party are applied.

At this time, of course, the game control unit 113 may apply all movement attributes of the selection character having a plurality of movement attributes among the selection characters to the movement of the movement coordinate B.

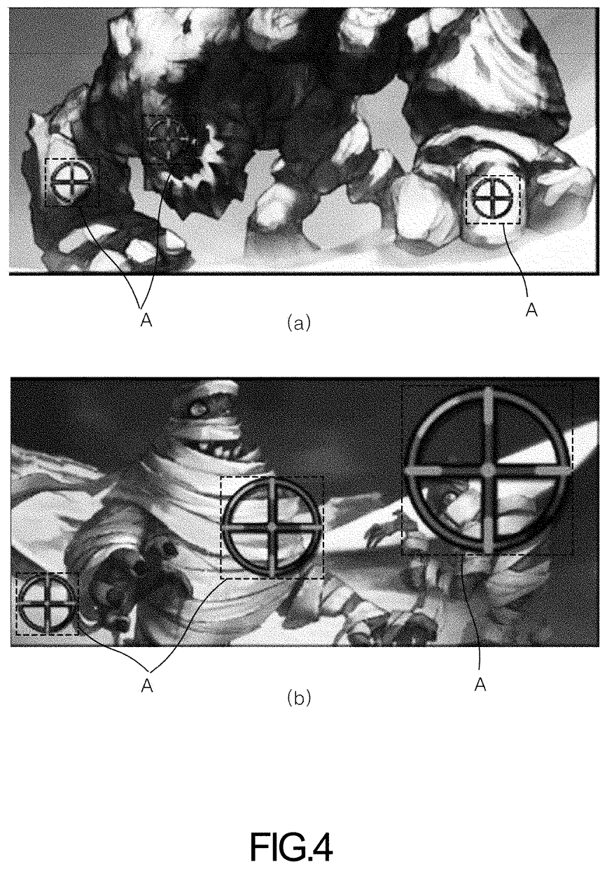

Meanwhile, in the aforementioned configuration, with respect to the attack region A, as illustrated in FIG. 4A, a plurality of attack regions A may be set according to the target information corresponding to the selection stage, and as illustrated in FIG. 4B, a range (size) of the attack region A maybe differently set according to a predetermined difficulty level to correspond to the selection stage.

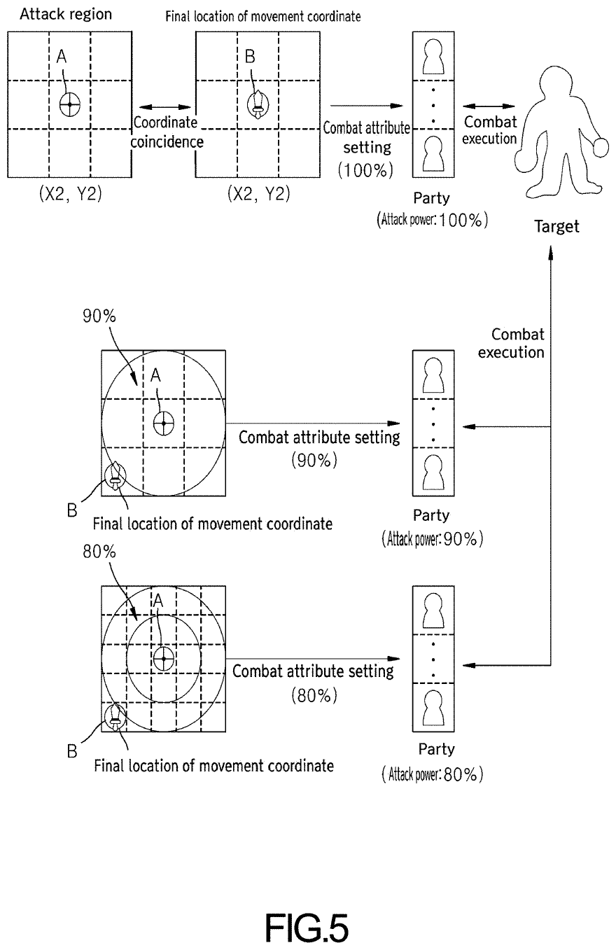

Meanwhile, as illustrated in FIG. 5, the game control unit 113 may move the movement coordinate B to the final location when the party configuration is completed and then execute the combat between the selection character included in the party and the target.

At this time, as illustrated in FIG. 5, the game control unit 113 may set combat attributes of all the selection characters included in the party to 100% when the final location of the movement coordinate B is included in the attack region A, and execute the combat between the selection character included in the party and the target automatically according to a predetermined simulation logic based on the combat attribute of the target and the combat attribute of the selection character included in the party.

For example, the game control unit 113 may execute the combat between the selection character included in the party and the target by applying the combat attribute of the target and the combat attribute of the selection character to the simulation logic.

In addition, the game control unit 113 may vary the combat attribute of the selection character according to the corresponding item with respect to the selection character having the item set according to the item information to apply the varied combat attribute to the simulation logic.

Further, as illustrated in FIG. 5, the game control unit 113 may calculate a separation distance between the attack region A and the movement coordinate B when the final location of the movement coordinate B is not included in the attack region A and reduce the combat attribute of the selection character included in the party to a predetermined ratio according to the separation distance.

For example, the game control unit 113 may set a target based on the attack region A and in the target, a reduction ratio of the combat attribute may be set for each different region constituting the target. In this case, the game control unit 113 may vary the size of each region constituting the target according to the size of the attack region A.

Accordingly, the game control unit 113 may reduce the combat attribute for each selection character included in the party according to the reduction ratio of the combat attribute set in the region where the movement coordinate B is located in the target according to the final location of the movement coordinate B and increase the reduction ratio of the combat attribute of the selection character included in the party as the final location of the movement coordinate B is far away from the attack region A.

For example, the game control unit 113 may set the combat attribute of the selection character included in the party to 90% when the final location of the movement coordinate B is not included in the attack region A, but included in the region of the target which reduces the combat attribute to a ratio of 10%.

In this case, the game control unit 113 may set the attack level of the selection character included in the combat attribute to 90%, or lower the combat attribute of the selection character in the same manner as to set the attack speed of the selection character to 90%.

In more detail, the game control unit 113 may decrease at least one of the attack level (damage level) and the defense level among the combat attributes of the selection character to a reduction ratio according to the final location of the movement coordinate B.

Meanwhile, the game control unit 113 may execute the combat with the target using the selection character included in the party based on the combat attribute of each selection character included in the party and the combat attribute of the target determined by considering the final location of the movement coordinate B and the attack region A.

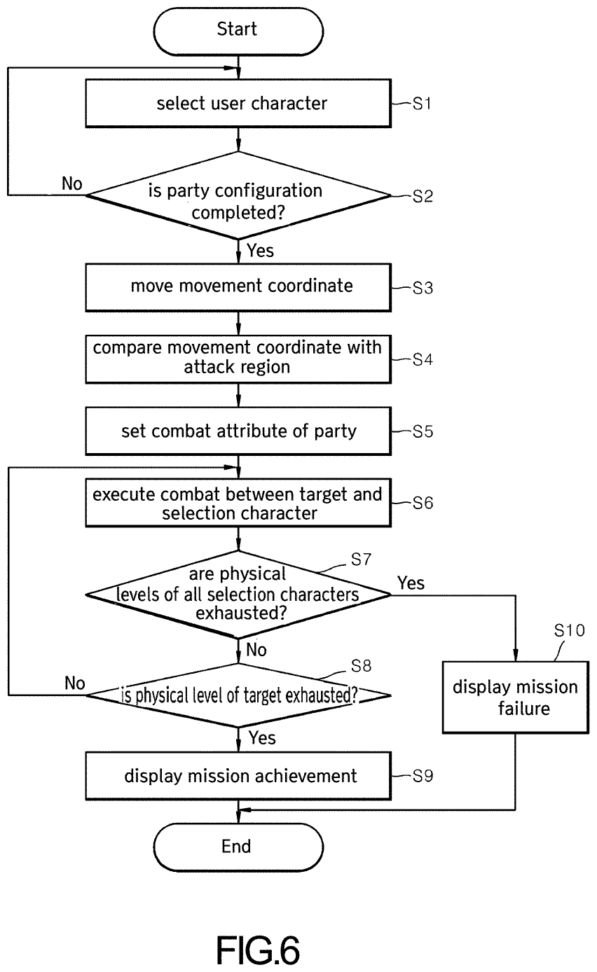

In this case, a process of executing the combat of the game control unit 113 is described through the flowchart of FIG. 6.

First, the game executing unit 111 may provide the game information through the user apparatus 100, execute the game corresponding to the stage selected by the user based on the game information, and provide the target image corresponding to the stage to the game screen through the display unit 130 of the user apparatus 100.

Further, the target providing unit 112 may set a coordinate system preset in the game information in the target image to correspond to the stage and display the attack region of the target preset in the game information on the target image.

Meanwhile, the game control unit 113 may display the movement coordinate moving on the coordinate system when executing the game in association with the game executing unit 111 and the target providing unit 112 and display the character list information including the character information for each of the plurality of user characters possessed by the user on the game screen together with the target image.

Thereafter, the game control unit 113 may configure a party based on one or more selection characters selected by the user among the plurality of user characters included in the character list information according to the user input by the input unit (S1), and move the movement coordinate B displayed on the target image to the starting point (initial location) based on the movement attribute of each selection character included in the party (S3) when the party configuration is completed (S2).

Further, the game control unit 112 may compare the attack region A with the final location of the movement coordinate B (S4), and set the combat attribute of the selection character constituting the party by considering the attack region A and the final location (S5).

Thereafter, the game control unit 113 may execute the combat between all the selection characters constituting the party and the target automatically according to the predetermined simulation logic based on the combat attribute of the selection character constituting the party set according to the attack region A and the final location of the movement coordinate B and the combat attribute preset to correspond to the target (S6).

Next, the game control unit 113 may execute the combat between all of the selection characters and the target for each step according to a preset combat executing step according to the simulation logic, and each of all of the selection characters and the target may be preset in the physical level to reduce (deduce or deplete) at least one physical level of all of the selection characters and the target by a measurement value measured in the combat executing step every combat execution step.

Thereafter, the game control unit 113 may determine that the achievement of the mission corresponding to the selection stage is failed (S10) when the physical level of all of the selection characters constituting the party is exhausted (S7) before the physical level of the target is exhausted and end the game corresponding to the selection stage after displaying result information about the mission failure on the display unit 130 of the user apparatus 100.

Further, the game control unit 113 determines that the mission achievement is successful (S9) when the physical level of the target is first exhausted (S8) before the physical level of all of the selection characters constituting the party is exhausted and may end the game corresponding to the selection stage after displaying result information about the mission success on the display unit 130.

Further, the game control unit 113 may store the result information in the storage unit 150 when the game corresponding to the selection stage ends to record whether the mission of the selection stage is achieved.

In the aforementioned configuration, a separate physical level of the user character is not set and only the physical level of the target may be applied at the time of the combat execution, and as a result, the game control unit 113 may also proceed the game so as to prevent the mission failure from occurring according to the execution of the combat between all of the selection characters constituting the party and the target.

Further, the game control unit 113 may display time information about a time required for removing the target on the display unit 130 according to a combat attribute for each selection character constituting the party whenever the user character for the party configuration is selected.

Accordingly, the game control unit 113 may allow the time required for removing the target to be decreased when the user character having a high attack level according to the combat attribute is selected as a party member and may allow the time required for removing the target to be increased when a user character having a low attack level according to the combat attribute is selected as the party member.

Meanwhile, in the aforementioned configuration, the game control unit 113 may set each attack region A as a mission when there are a plurality of attack regions A preset to correspond to the selection stage and set a party corresponding to each attack region A according to the user input by the input unit 120.

In addition, the game control unit 113 may move the movement coordinate B from the current location to each attack region A corresponding to each party when setting a plurality of parties corresponding to the plurality of attack regions.

At this time, the game control unit 113 generates a plurality of movement coordinates B on the coordinate system according to the number of parties generated to correspond to the same target to move the movement coordinate B corresponding to each party to the attack region A corresponding to the movement coordinate according to the movement attribute for each selection character of the party corresponding to the movement coordinate B.

At this time, the starting points of the different movement coordinates B may be the same as or different from each other.

Further, the game control unit 113 may execute the combat based on the combat attribute of the target set in the target information and the combat attribute of the party corresponding to the movement coordinate to correspond to the attack region A corresponding to the final location of the movement coordinate B with respect to each movement coordinate B and determine whether the mission is achieved according to the combat execution for each attack region.

At this time, in the target information, different combat attributes may also be set for each different attack region A for the same target and different parties include the same user character or at least some of the parties may be configured by different user characters.

Further, in the stage information or the target information, of course, the setting information about the selection number of different characters (or the character selectable number) for the party configuration for each different attack region A for the same target, and the game control unit 113 may limit the number of selectable user characters for each attack region according to the setting information.

In other words, the game control unit 113 may limit the number of user characters constituting the party to five with respect to a first attack region of the same target and limit the number of user characters to seven with respect to a second attack region of the same target according to the setting information. As a result, the user may select a user character from five user characters as the selection character for the party configuration with respect to the first attack region and select a user character from seven user characters as the selection character for the party configuration with respect to the second attack region.

At this time, of course, the setting information may be set to be selectable the same number of user characters to correspond to the first attack region and the second attack region.

Accordingly, the game control unit 113 may provide result information about the mission success of the selection stage when the achievement of the mission for all the attack regions A of the target corresponding to the selection stage is successful.

Further, the game control unit 113 may output the result information about the mission failure of the selection stage on the display unit 130 when the achievement of the mission for anyone attack region A is failed by applying the physical level of the user character when executing the combat.

On the other hand, mission information about the mission achievement conditions may be set for each stage, and the game control unit 113 may determine whether the mission is achieved according to the mission information corresponding to the selection stage.

Further, the mission information may be included in the stage information, and of course, in the mission information, various mission achievement conditions may be set by various methods in addition to the aforementioned examples.

Further, in the aforementioned configuration, the target may be set as various objects such as a monster or a citadel corresponding to the stage, and the attack region A may be set as various elements such as a weak point of the monster or a specific part of the citadel.

In addition, the game control unit 113 may provide a compensation according to the compensation information when the mission is achieved based on the compensation information according to the stage information. For example, the user provides an additional character as a usable user character to register the character in the character list information or increase a level for each parameter constituting the combat attribute of the user character by a set value set in the compensation information.

According to the aforementioned configuration, the present invention provides a coordinate attack game so that the attack for the attack region A is performed by moving the movement coordinate B aiming the attack region A to approach the attack region A for attacking the target to provide a new genre of game by combining a shooting genre of hitting the attack region A by moving the movement coordinate B corresponding to the aiming point and a strategy simulation genre of attacking the attack region A by disposing a user character constituting the party at a specific point according to the movement of the movement coordinate B, thereby providing a game capable of inspiring an interest of users who are bored with the existing uniform genre.

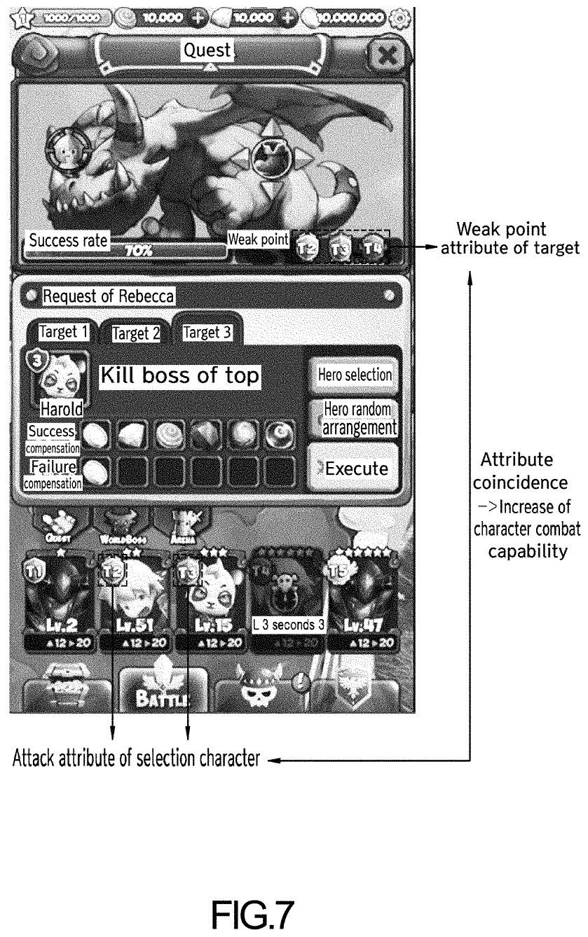

Meanwhile, the present invention will be described in detail with reference to FIG. 7, in which in order to secure a variety of strategies related to the attack of the target which is an attack object of the coordinate attack game, at least one of various types of weak point attributes and tolerance attributes is set in the combat attribute of the target and an attack attribute corresponding to the weak point attribute and the tolerance attribute may be set in the user character, and the attack level according to the combat attribute of the selection character is varied according to a compatibility criterion preset according to the weak point attribute and the tolerance attribute of the target and the attack attribute of the selection character constituting the party to support various game progress aspects when executing the combat between the target and the selection character.

As illustrated in FIG. 7, the target information includes defense attribute information about at least one of a weak point attribute and a tolerance attribute of the target and the character information may include attack attribute information about the same type of attack attribute as the weak point attribute and the tolerance attribute.

In this case, when there is a plurality of attack regions A of the target, the defense attribute information may be differently set to correspond to each attack region A.

Further, the target information may include compatibility information about a weight applied to the attack level of the selection character for each type of the weak point attribute and the tolerance attribute.

For example, the weak point attribute and the tolerance attribute may be configured by at least one of various types of element attributes such as fire, water, wind, wood, metal, and soil, and with respect to the target, the fire may be set as the weak point attribute and the water may be set as the tolerance attribute.

In addition, the attack attribute of the user character may also be set with at least one of the element attributes corresponding to the weak point attribute and the tolerance attribute.

That is, the attack attribute may be configured to have compatibility with at least one of the weak point attribute and the tolerance attribute.

Further, the weak point attribute, the tolerance attribute, and the attack attribute maybe classified in advance to correspond to the user character and may be set to at least one of a plurality of levels.

Further, the compatibility information of the target may increase the attack level of the user character having water set as the weak point attribute from 100% to 120% or decrease the attack level of the user character having fire and water set as the compatibility from 100% to 90%.

In this case, the attack level may mean the degree of damage or attack accuracy of reducing the physical level of the target when the user character succeeds the attack on the target.

Accordingly, the game control unit 113 may execute the combat by applying a weight according to the compatibility information to the attack level of the selection character having the attack attribute coinciding with the weak point attribute or the tolerance attribute of the target based on the compatibility information included in the target information, the attack attribute according to the character information of each selection character constituting the party, and the weak point attribute and the tolerance attribute preset according to the target information of the target when executing the combat between the selection character constituting the party and the target.

Accordingly, the game control unit 113 may increase the attack level of the selection character according to a weight in an attack executing step (combat executing step) of the selection character having the attack attribute coinciding with the weak point attribute of the target to reduce the physical level of the target according to the increased attack level, and may decrease the attack level of the selection character according to the weight in the attack executing step of the selection character having the attack attribute coinciding with the tolerance attribute of the target to decrease the physical level of the target according to the decreased attack level.

According to the aforementioned configuration, in the present invention, the user establishes an optimal strategy and achieves the mission by considering a method of combining user characters capable of moving the movement coordinate B to be closest to the attack region A of the target when the user selects and combines the plurality of user characters to configure the party for removing the target and a method of combining the user characters according to a combat attribute interacting between the target and the user character to efficiently remove the target when executing the combat between the target and the user character, thereby inspiring an interest of the user for the game by excluding a uniform strategy while securing variety of games by supporting various user characters to be combined to achieve the mission for the same target.

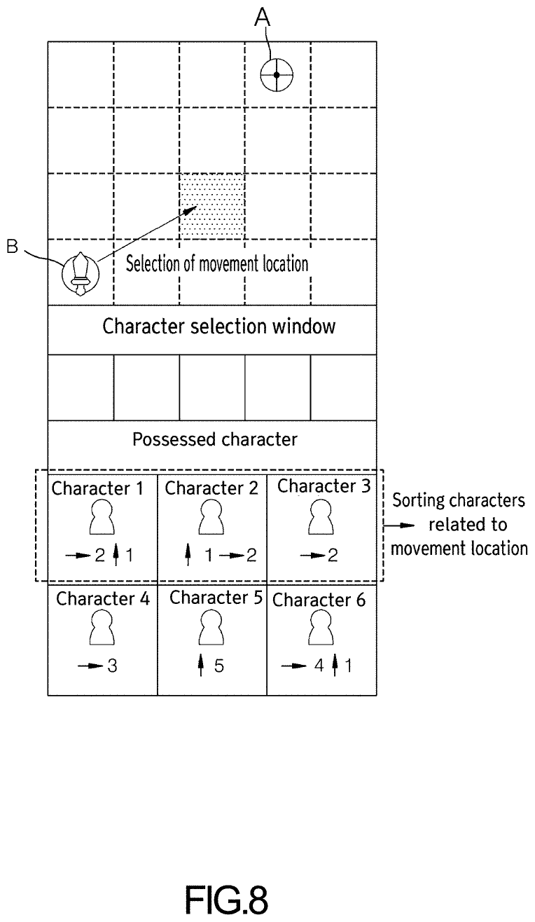

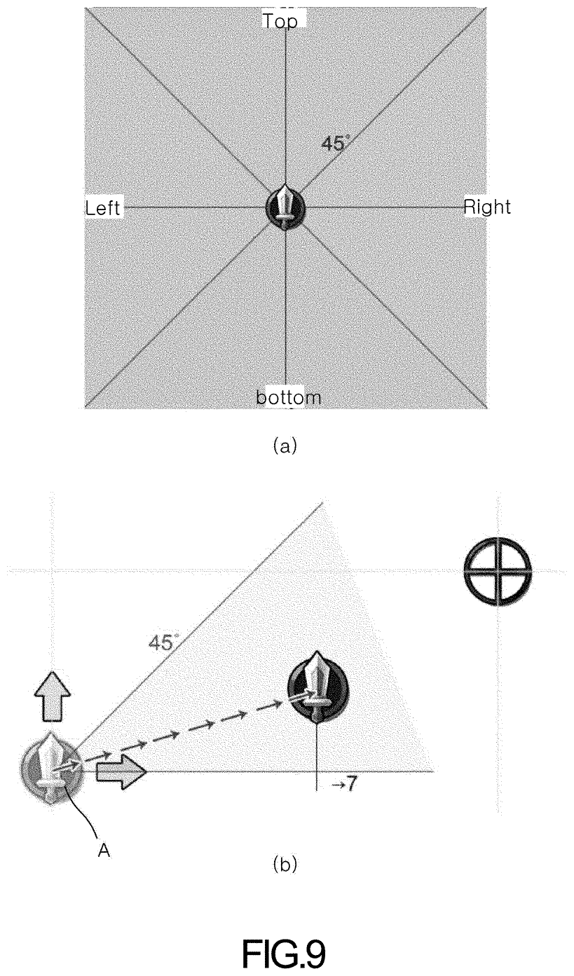

Meanwhile, the game control unit 113 sorts and provides an associated character related with the corresponding selection location among the user characters possessed by the user when the user receives a selection location for the movement coordinate B which is a user's desired location based on the user input by the input unit 120, thereby improving a game progress speed while enhancing ease of the character selection and the game progression to achieve the mission, and this will be described in detail with reference to FIGS. 8 and 9.

First, as illustrated in FIG. 8, the game control unit 113 may set a selection location for a user's desired location of the movement coordinate B based on the user input by the input unit 120 of the user apparatus 100 in the coordinate system set in the target image.

Further, as illustrated in FIG. 9A, the game control unit 113 may measure an angle with the selection location based on the current location of the movement coordinate B when setting the selection location and divide a range based on 45° in a vertical or horizontal direction at the current location and then identify a range in which the angle between the current location and the selected location is included to identify a movement direction corresponding to the selection location at top, down, left, and right.

For example, the game control unit 113 may determine the movement direction as a right direction when the angle between the current location and the selection location is 25° and determine the movement direction as a left direction when the angle between the current location and the selection location is 130°.

Further, as illustrated in FIG. 9B, the game control unit 113 may identify one or more user characters having the movement attribute corresponding to the identified movement direction to correspond to the movement location, calculate the movement location according to the movement attribute for each identified user character based on the current location, compare the movement location for each user character with the selection location to generate character list information by arranging one or more user characters possessed by the user in an order of approaching the selection location, and then display the generated character list information on the display unit 130 of the user apparatus 100.

Accordingly, the game control unit 113 presents the user character having the movement character capable of closely locating the movement coordinate B to the selection location of the user, thereby increasing an interest on the game by increasing the progression speed of the game while enhancing the ease for the game progression of the user.

Meanwhile, in the aforementioned configuration, at least some of the configuration units of the game application unit 110 are configured in a server communicating with the user apparatus 100 and the remaining configuration units may be configured in a control unit of the user apparatus 100, and the corresponding server may transmit various information and contents provided from the game application unit 110 to the user apparatus 100.

Further, the user apparatus 100 may further include a communication unit, and the control unit constituted in the user apparatus 100 may communicate with the server through the corresponding communication unit and perform a function of the game application unit 110 using the information and contents received from the server.

For example, the control unit receives character information related with an additional user character according to the compensation information from the server to include the received character information in the character list information or receives the item information to apply the item information to the user character.

Furthermore, in the aforementioned configuration, the target image may be configured as a 3D stereoscopic image, and as a result, the coordinate system may also be configured in 3D.

Further, the game control unit 113 may move the movement coordinate B in 3D to correspond to the 3D coordinate system, and the movement attribute set in the user character may also be set by a 3D direction as well as a 2D direction, and a movement distance.

As described above, according to the present invention, a coordinate attack game may be provided which moves movement coordinates aiming at an attack region A in accordance with movement attributes set in a plurality of user characters constituting a party so as to approach the attack region A for attacking a target and executes a combat between the party constituted by the plurality of user characters according to the corresponding movement coordinates and executes the combat by varying a combat attribute of the user character according to aiming accuracy of the movement coordinates for the attack region A to provide a game that inspires an interest of a user who becomes bored with the existing uniformed genre and guarantees a fun to attack various attacks having different attack regions A by providing a new genre of game in which an FPS genre to attack the attack region A by moving movement coordinates corresponding to an aiming point and a strategy simulation genre to attack the attack region A by arranging user characters constituting a party at a specific point with movement of the movement coordinates.

Further, according to the present invention, a game may be provided, which a beginner may also easily access through a simple operation of combining the plurality of user characters into the party.

Furthermore, a user provides a mission to be achieved only by establishing an optimal strategy by considering both a scheme of combining user characters that may move movement coordinates closest to the attack region A of the target at the time of constituting a party for removing the target by using the plurality of user characters and a scheme of the user characters according to a combat attribute which is interacted between the target and the user character in order to efficiently remove the target at the time of executing the combat between the target and the user character to guarantee diversity of the game and exclude a uniformed strategy by supporting the combination of various user characters to be generated with respect to the same target, thereby inspiring an interest of the user in the game.

Various apparatuses and components described in the present specification may be embodied by a hardware circuit (for example, a CMOS based logic circuit), firmware, software, or combinations thereof. For example, the apparatuses and components may be embodied by using a transistor, a logic gate, and an electronic circuit in the forms of various electric structures.

The operations according to the exemplary embodiments are implemented in a form of a program command which may be performed through various computer means and may be recorded in the computer readable medium. The computer readable medium may include singly a program command, a data file, or a data structure or a combination thereof. The program command recorded in the medium may be specially designed and configured for the present invention, or may be publicly known to and used by those skilled in the computer software field. Examples of the computer-readable recording medium include magnetic media such as a hard disk, a floppy disk, and a magnetic tape, optical media such as a CD-ROM and a DVD, magneto-optical media such as a floptical disk, and a hardware device which is specifically configured to store and execute the program command such as a ROM, a RAM, and a flash memory. An example of the program command includes a high-level language code executable by a computer by using an interpreter and the like, as well as a machine language code created by a compiler. The hardware device may be configured to be operated with one or more software modules in order to perform the operation of the present invention and vice versa.

The aforementioned contents can be corrected and modified by those skilled in the art without departing from the essential characteristics of the present invention. Accordingly, the various embodiments disclosed herein are not intended to limit the technical spirit but describe with the true scope and spirit being indicated by the following claims. The protection scope of the present invention should be construed based on the following appended claims and it should be appreciated that the technical spirit included within the scope equivalent to the claims belongs to the present invention.

What is claimed is:

1. A gaming system for attack targeted at coordinates, comprising:
a game executing unit configured to
provide game information through a user apparatus and
execute a game corresponding to a stage selected by a user based on the game information;
a target providing unit configured to
display a target image for a target corresponding to the stage in association with the game executing unit,
set a coordinate system preset in the game information in the target image to correspond to the stage, and
display an attack region of the target preset in the game information on the target image; and
a game control unit configured to
configure a party by grouping one or more selection characters selected according to a user input through the user apparatus within the number of selected characters preset to correspond to the stage among a plurality of different user characters included in the game information,
set a starting point of the party on a coordinate system of the target image and display a movement coordinate which moves on the coordinate system at the starting point, and
execute a combat between the target and the selection character according to the game information by considering a final location of the movement coordinate and the attack region on the coordinate system by moving the movement coordinate on the coordinate system according to a movement attribute for each selection character included in the party.

2. The gaming system for attack targeted at coordinates of claim 1, wherein the game control unit identifies a difficulty level corresponding to the target set in the game information and varies a resolution of the coordinate system or varies a size of the attack region according to the identified difficulty level.

3. The gaming system for attack targeted at coordinates of claim 1, wherein the movement attribute includes a movement direction and a movement distance, and
the game control unit moves the movement coordinate on the coordinate system according to the movement direction and the movement distance depending on the movement attribute set in the selection character.

4. The gaming system for attack targeted at coordinates of claim 1, wherein the game information includes information on a combat attribute including a physical level and an attack level for each of the user character and the target, and
the game control unit varies the combat attribute of the selection character according to a separation distance depending on the attack region and a final location of the movement coordinate, subtracts the physical level of the target by executing the combat based on the combat attributes of the selection character and the target, and outputs result information for a determination result by determining whether a mission is achieved according to whether the physical level of the target is exhausted through the user apparatus.

5. The gaming system for attack targeted at coordinates of claim 4, wherein the game control unit displays each attack region on the target image when there are a plurality of attack regions corresponding to the target, determines whether the mission is achieved for each attack region by executing the combat after moving the movement coordinate to each attack region from the starting point according to the movement attribute of each party by generating a plurality of parties corresponding to the plurality of attack regions according to a user input, and determines that the achievement of the mission for the stage is successful when the achievement of the mission for all attack regions of the target is successful.

6. The gaming system for attack targeted at coordinates of claim 4, wherein the game information includes information on a weak point attribute and a tolerance attribute of the target corresponding to the attack region and an attack attribute of the selection character, and
the game control unit applies a weight preset in the game information to the combat attribute of the selection character of which the attack attribute coincides with anyone of the weak point attribute and the tolerance attribute and subtracts the physical level of the target according to the combat attribute to which the weight is applied at the time of executing the combat.

7. The gaming system for attack targeted at coordinates of claim 6, wherein the weak point attribute and the tolerance attribute and the attach attribute are attributes set to have a preset grade or compatibility to correspond to the user character.

8. The gaming system for attack targeted at coordinates of claim 1, wherein the game control unit calculates a movement direction depending on an angle between a selection location and a current location of the movement coordinate selected according to the user input and a movement location of the movement coordinate depending on the movement attribute for each user character and sorts and displays the user characters in an order in which the selection location and the movement location are closer according to a calculation result.

9. The gaming system for attack targeted at coordinates of claim 1, wherein the target image is configured by a 3D stereoscopic image, the coordinate system is configured in 3D, and the movement attribute includes a 3D movement direction and a 3D movement distance.

10. A gaming method for attack targeted at coordinates by a game application unit configured in a user apparatus and executing a game, the method comprising:
providing game information through the user apparatus, executing a game corresponding a stage selected by a user based on the game information, and providing a target image corresponding to the stage to a game screen through a display of the user apparatus;
setting a coordinate system preset in the game information in the target image to correspond to the stage and displaying an attack region of the target preset in the game information on the target image;
displaying a movement coordinate which moves on the coordinate system; and
configuring a party by grouping one or more selection characters selected according to a user input through the user apparatus within the number of selected characters preset to correspond to the stage among a plurality of different user characters included in the game information and executing a combat between the target and the selection character according to the game information by considering a final location of the movement coordinate and the attack region on the coordinate system by moving the movement coordinate on the coordinate system according to a movement attribute for each selection character included in the party.
